(19) United States
(12) Patent Application Publication
(10) Pub. No.: US 2023/0365012 A1
(43) Pub. Date: Nov. 16, 2023

(54) CHARGING TO AND/OR FROM A VEHICLE USING A SCALABLE BUCK-BOOST SYSTEM

(71) Applicant: GM GLOBAL TECHNOLOGY OPERATIONS LLC, Detroit, MI (US)

(72) Inventors: Chandra S. Namuduri, Troy, MI (US); Lei Hao, Troy, MI (US); Rashmi Prasad, Troy, MI (US); Rasoul Hosseini, Troy, MI (US); Venkata Prasad Atluri, Novi, MI (US); Chengwu Duan, Shanghai (CN)

(21) Appl. No.: 17/742,598

(22) Filed: May 12, 2022

(51) Int. Cl. B60L 53/22; H02J 7/00; H02M 3/158; H02M 3/335; B60L 58/16

(52) U.S. Cl. CPC B60L 53/22; B60L 58/16; H02J 7/0047; H02J 7/0063; H02J 7/00712; H02M 3/1582; H02M 3/33584; B60L 2210/12; B60L 2210/14; H02J 2207/20

(57) ABSTRACT

A charging system for a vehicle includes a conversion device configured to transfer an electric charge between a battery assembly of the vehicle and an energy storage system, the battery assembly having a first voltage and the energy storage system having a second voltage, the conversion device including a scalable buck-boost system having a plurality of buck-boost modules. Each buck-boost module of the plurality of buck-boost modules includes a set of switches and an inductor. The charging system also includes a controller configured to operate one or more buck-boost modules of the plurality of buck-boost modules during transfer of charge between the battery assembly and the energy storage system.

### INTRODUCTION

The subject disclosure relates to batteries and battery assemblies, and more particularly to monitoring of battery health.

Vehicles, including gasoline and diesel power vehicles, as well as electric and hybrid electric vehicles, feature battery storage for purposes such as powering electric motors, electronics and other vehicle subsystems. Battery assemblies may be charged using dedicated charging stations and other power sources such as residences and building connected to a power grid. In addition, some vehicles may have the capability to transfer power to external locations, such as by supplying power to battery assemblies of other vehicles and/or to a grid.

### SUMMARY

In one exemplary embodiment, a charging system of a vehicle includes a conversion device configured to transfer an electric charge between a battery assembly of the vehicle and an energy storage system, the battery assembly having a first voltage and the energy storage system having a second voltage, the conversion device including a scalable buck-boost system having a plurality of buck-boost modules. Each buck-boost module of the plurality of buck-boost modules includes a set of switches and an inductor. The charging system also includes a controller configured to operate one or more buck-boost modules of the plurality of buck-boost modules during transfer of charge between the battery assembly and the energy storage system.

In addition to one or more of the features described herein, the first voltage is greater than the second voltage.

In addition to one or more of the features described herein, the set of switches includes a half bridge switch module or a full bridge switch module.

In addition to one or more of the features described herein, the scalable buck-boost system includes at least one of a standalone conversion device, and one or more components of a vehicle propulsion assembly.

In addition to one or more of the features described herein, each buck-boost module includes a dual active bridge circuit configured for bi-directional power flow.

In addition to one or more of the features described herein, the buck-boost system includes an input capacitor and an output capacitor connected to the plurality of buck-boost modules.

In addition to one or more of the features described herein, the controller is configured to operate one or more selected buck-boost modules, a number of the selected buck-boost modules determined based on a charging parameter of at least one of the battery assembly and the energy storage system.

In addition to one or more of the features described herein, the controller is configured to selectively operate different buck-boost modules to balance a thermal distribution of the conversion device.

In another exemplary embodiment, a method of transferring charge includes connecting a charging system of a vehicle to an energy storage system, the charging system configured to control energy transfer to and from a battery assembly of the vehicle, the battery assembly having a first voltage and the energy storage system having a second voltage. The charging system includes a conversion device, the conversion device including a scalable buck-boost system having a plurality of buck-boost modules, and each buck-boost module of the plurality of buck-boost modules includes a set of switches and an inductor. The method also includes transferring charge between the battery assembly and the energy storage system, where the transferring includes operating one or more buck-boost modules of the plurality of buck-boost modules by a controller to conform an output voltage to the first voltage or the second voltage.

In addition to one or more of the features described herein, the energy transfer is from the battery assembly to the energy storage system.

In addition to one or more of the features described herein, the first voltage is greater than the second voltage, and at least one of the plurality of buck-boost modules is controlled to reduce an input voltage from the battery assembly to an output voltage corresponding to the second voltage.

In addition to one or more of the features described herein, the first voltage is less than the second voltage, and at least one of the plurality of buck-boost modules is controlled to increase an input voltage from the battery assembly to an output voltage corresponding to the second voltage.

In yet another exemplary embodiment, a vehicle system includes a battery assembly and a charging system configured to transfer an electric charge between the battery assembly and an energy storage system, the battery assembly having a first voltage and the energy storage system having a second voltage. The charging system includes a conversion device including a scalable buck-boost system having a plurality of buck-boost modules, each buck-boost module of the plurality of buck-boost modules including a set of switches and an inductor, and a controller configured to operate one or more buck-boost modules of the plurality of buck-boost modules during transfer of charge between the battery assembly and the energy storage system.

In addition to one or more of the features described herein, the first voltage is greater than the second voltage.

In addition to one or more of the features described herein, the set of switches includes a half bridge switch module or a full bridge switch module.

In addition to one or more of the features described herein, the scalable buck-boost system includes at least one of a standalone conversion device, and one or more components of a vehicle propulsion assembly.

In addition to one or more of the features described herein, each buck-boost module includes a dual active bridge circuit configured for bi-directional power flow.

In addition to one or more of the features described herein, the buck-boost system includes an input capacitor and an output capacitor connected to the plurality of buck-boost modules.

In addition to one or more of the features described herein, the controller is configured to operate one or more selected buck-boost modules, a number of the selected buck-boost modules determined based on a charging parameter of at least one of the battery assembly and the energy storage system.

In addition to one or more of the features described herein, the controller is configured to selectively operate different buck-boost modules to balance a thermal distribution of the conversion device.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top schematic view of a motor vehicle including a battery assembly and a charging system, in accordance with an exemplary embodiment;

FIG. 2 depicts a conversion device including at least one half bridge buck-boost module for facilitating charge or energy transfer, in accordance with an exemplary embodiment;

FIG. 3 depicts a conversion device including at least one full bridge buck-boost module for facilitating charge or energy transfer, in accordance with an exemplary embodiment;

FIG. 4 depicts a conversion device including at least one buck-boost module having a set of switches connected to an inductor of a vehicle motor;

FIG. 5 depicts a conversion device including at least one buck-boost module having a set of switches connected to an inductor of a vehicle motor;

FIG. 6 depicts a conversion device including at least one dual active bridge module for facilitating charge or energy transfer, in accordance with an exemplary embodiment;

FIG. 7 is a flow diagram depicting aspects of a method of transferring charge or energy between a first vehicle and a second vehicle, in accordance with an exemplary embodiment;

FIG. 8 is a flow diagram depicting aspects of a method of transferring charge or energy between a vehicle battery assembly and a charge station or other energy storage system, in accordance with an exemplary embodiment; and

FIG. 9 depicts a computer system in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with one or more exemplary embodiments, methods, devices and systems are provided for transferring charge or energy to a vehicle battery assembly and/or transferring charge or energy from a vehicle battery assembly to another energy storage system (e.g., another vehicle or a power grid). An embodiment of a vehicle charging system includes a conversion device having a scalable buck-boost system configured to adjust an input voltage to accommodate charging between storage systems having different voltage ratings. The buck-boost system includes one or more buck-boost modules, each of which includes a set of switches in a half-bridge or full bridge configuration, and an inductor. Each buck-boost module can raise (“boost”) or lower (“buck”) an input voltage to accommodate voltage differences between the system being charged and another energy storage system or power source. The scalable buck-boost system (or components thereof) can be a modular or additional unit (i.e., a standalone unit) installed in a vehicle, incorporate existing vehicle components, or both. For example, the buck-boost system may be in the form of a standalone buck boost DC-DC converter, incorporate components of a vehicle propulsion assembly (e.g., a motor inverter system) for use as part of the buck-boost system, or a combination thereof. The buck-boost system may be a half bridge system and can function in a boost mode in one direction (e.g., from another storage system to the vehicle battery assembly) and in a buck mode in another direction (e.g., from the vehicle battery system to another storage system). The buck-boost system may be a full bridge system and can function in a buck mode and a boost mode in both directions.

Any number of buck-boost modules may be included in the buck-boost system, and each module may be integrated into a vehicle’s charging system or provided as a modular add-on. A controller is provided to control aspects of energy transfer. If the buck-boost system has multiple buck-boost modules, the controller can operate the modules in coordination for purposes such as managing thermal conditions and reducing or minimizing current ripple.

Embodiments described herein present numerous advantages and technical effects. For example, the embodiments provide for an efficient energy transfer system that can accommodate mismatches in voltage between a power source and an energy storage system being charged. In addition, the embodiments provide a conversion device that can be easily scaled to accommodate various charging parameters (e.g., load currents), provide redundancy and/or for thermal management.

The embodiments are not limited to use with any specific vehicle or device or system that utilizes battery assemblies, and may be applicable to various contexts. For example, embodiments may be used with automobiles, trucks, aircraft, construction equipment, farm equipment, automated factory equipment and/or any other device or system that may use high voltage battery packs or other battery assemblies.

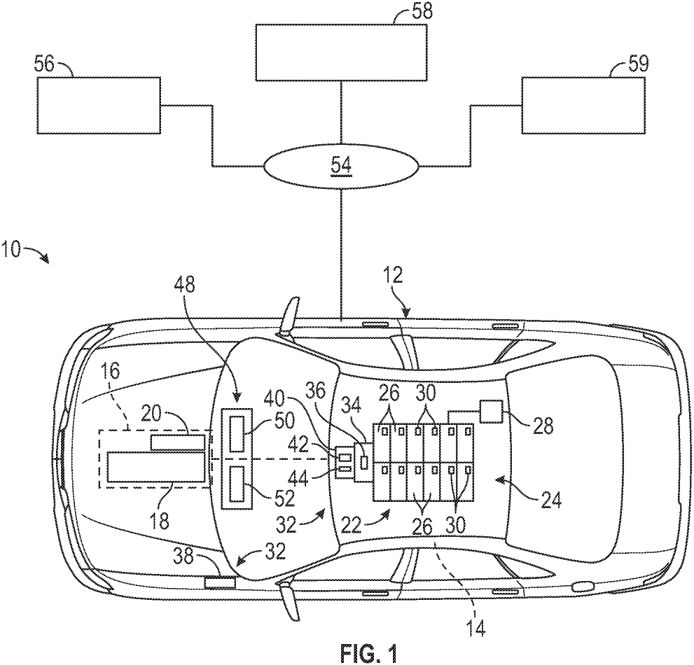

FIG. 1 shows an embodiment of a motor vehicle 10, which includes a vehicle body 12 defining, at least in part, an occupant compartment 14. The vehicle body 12 also supports various vehicle subsystems including a propulsion assembly 16, and other subsystems to support functions of the propulsion assembly 16 and other vehicle components, such as a braking subsystem, a suspension system, a steering subsystem, a fuel injection subsystem, an exhaust subsystem and others.

The vehicle may be a combustion engine vehicle, an electrically powered vehicle (EV) or a hybrid electric vehicle (HEV). In an example, the vehicle 10 is a hybrid vehicle that includes a combustion engine assembly 18 and an electric motor assembly 20.

The vehicle 10 includes a battery system 22, which may be electrically connected to the motor assembly 20 and/or other components, such as vehicle electronics. In an embodiment, the battery system 22 includes a battery assembly such as a high voltage battery pack 24 having a plurality of battery modules 26. Each of the battery modules 26 includes a number of individual cells (not shown). The battery system 22 may also include a monitoring unit 28 configured to receive measurements from sensors 30. Each sensor 30 may be an assembly or system having one or more sensors for measuring various battery and environmental parameters, such as temperature, current and voltages. The monitoring unit 28 includes components such as a processor, memory, an interface, a bus and/or other suitable components.

The vehicle 10 includes a charging system 32 that can be used to charge the battery pack 24 and/or used for supplying power from the battery pack 24 to charge another energy storage system. The charging system 32 includes an onboard charging module (OBCM) 34 having a DC-DC converter 36 that is electrically connected to a charge port 38. The charging system 32 also includes a conversion device 40 configured to step up or step down an input voltage for efficient charge transfer between storage systems having different voltage ratings or operating voltages. The conversion device 40 may be a standalone device, or a vehicle component or system can be configured to provide conversion functionality. For example, components of the propulsion assembly 16 can be used as all or part of the conversion device 40. The conversion device 40 can provide backward compatibility, so that energy transfer can be efficiently performed between a higher voltage energy storage system (e.g., an 800 Volt (V) vehicle battery pack and a 400 V charge station).

As discussed further herein, the conversion device 40 (whether configured as a separate unit or using components of the propulsion assembly 16 and/or other components for conversion) includes at least one buck-boost module 42 including a set of switches (e.g., low loss controllable switches such as metal-oxide-semiconductor field-effect transistors (MOSFETs)) connected to an inductor. The conversion device 40 also includes a processing device or unit, referred to as a controller 44, for controlling the buck-boost module(s) 42. It is noted that the conversion device 40 can be a modular unit that can be added on to an existing battery system, or can be integrated into the battery system (e.g., as part of the OCBM 34). In addition, the controller 44 may be a separate processing unit or may be incorporated as part of another vehicle processing unit.

The vehicle 10 also includes a computer system 48 that includes one or more processing devices 50 and a user interface 52. The various processing devices and units may communicate with one another via a communication device or system, such as a controller area network (CAN) or transmission control protocol (TCP) bus. In addition, the monitoring unit 28, the OCBM 34, the computer system 48 and/or other processing components in the vehicle may be configured to communicate with various remote devices and systems such as charge stations and other vehicles. Such communication can be realized, for example, via a network 54 (e.g., cellular network, etc.) and/or via wireless communication. For example, the vehicle 10 may communicate with one or more charging stations 56, a remote entity 58 (e.g., a workstation, a computer, a server, a service provider, a technician, an engineer, etc.), and/or a database or other storage location 59.

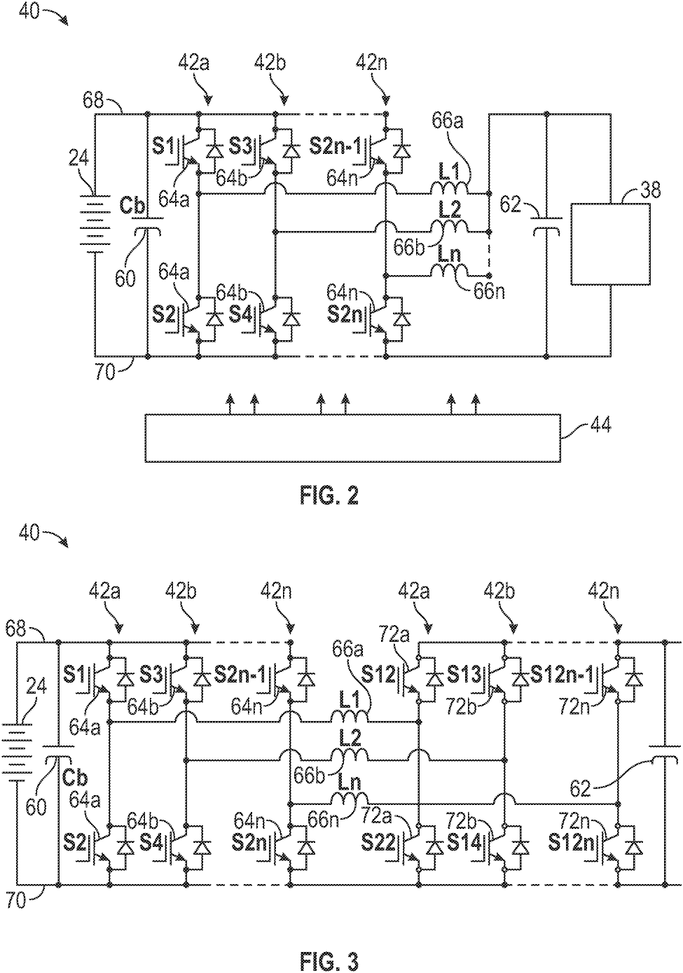

FIG. 2 depicts an embodiment of the conversion device 40. The conversion device 40, in this embodiment, includes one or more buck-boost modules 42. As discussed further herein, a buck-boost module 42 provides for compatibility between storage systems having different voltages. The conversion device 40 includes n buck-boost modules 42 (i.e., modules 42a, 42b . . . 42n) connected in parallel to one another and connected to the battery pack 24 and the charge port 38. The conversion device 40 is not limited to use with the battery pack 24 and the charge port 38, as the conversion service 40 can be connected to any suitable vehicle battery assembly and/or other storage system (e.g., another vehicle battery and/or a charging station).

The buck-boost module 42 may include additional components to facilitate energy transfer. For example, the conversion device 40 includes a capacitor 62 (Cin) at an input side (or charge port side) of the device 40 and a capacitor 60 (Cb) at an output side (or battery side) of the device 40 for filtering out current ripple.

The conversion device 40 includes n buck-boost modules 42, wherein n may be any desired number (i.e., one or more) of modules. Each buck boost module 42 includes a set of switches, which may be inverter switches. Each buck-boost module 42 may be in a half bridge configuration as shown in FIG. 2, or in a full bridge configuration as discussed below with reference to FIG. 3. In addition, each buck-boost module 42 includes a respective inductor.

For example, the conversion device 40 includes a first buck-boost module 42a, a second buck-boost module 42b and one or more additional buck-boost modules 42n. Each switch of the set of switches may include a bipolar transistor or field effect transistor (FET) switch, but is not so limited.

Referring to FIG. 2, the first buck-boost module 42a includes a first set of switches 64a (switch S1 and switch S2) connected to an inductor 66a (L1). the second buck-boost module 42b includes a second set of switches 64b (switch S3 and switch S4) connected to an inductor 66b (L2). Each additional buck-boost module 42n includes a set of switches 64n (including switch Sn-1 and switch Sn) connected to an inductor 66n (Ln). Each set of switches is connected to a positive bus 68 and a negative bus 70

The inductors 66a, 66b and 66n may be part of a removable or connectable module (e.g., to provide additional control capability in addition to the OCBM 34 or the DC-DC converter 36) or integrated into a vehicle system. For example, one or more of the inductors 66a, 66b and 66c may be a dedicated inductor or share an existing inductor such as a machine winding or an inductor of a propulsion inverter.

Each switch, in an embodiment, includes a solid-state relay and/or an electromechanical relay. A solid-state relay has no moving parts but instead uses the electrical and optical properties of solid-state semiconductors to perform its input to output isolation and switching functions. As non-limiting examples, solid-state relays include MOS-controlled Thyristors (MCTs), gallium-nitride (GaN) field-effect transistors (FETs), metal-oxide-semiconductor field-effect transistors (MOSFETs), silicon carbide junction field-effect transistors (SiC JFETs), insulated-gate bipolar transistors (IGBTs) or any other suitable low loss device of suitable voltage and current ratings. The switches may be electromechanical relays in parallel with solid state switches to further reduce the on-state conduction loses. During operation, the solid-state switches carry current during switching from on-to-off or off-to-on state of an electromechanical relay to eliminate arcing.

FIG. 3 depicts an embodiment of the conversion device 40, in which each buck-boost module 42 is in a full bridge configuration. In this embodiment, the first buck-boost module 42a includes the first set of switches 64a and an additional set of switches 72a (switch S11 and switch S12) connected to the inductor 66a. The second buck-boost module 42b includes the second set of switches 64b and an additional set of switches 72b (switch S13 and switch S14) connected to the inductor 66b. Each additional module 42n includes the set of switches 64n and an additional set of switches 72n (including switch S1n-1 and switch S1n) connected to the inductor 66n. Each set of switches is connected to the positive bus 68 and the negative bus 70.

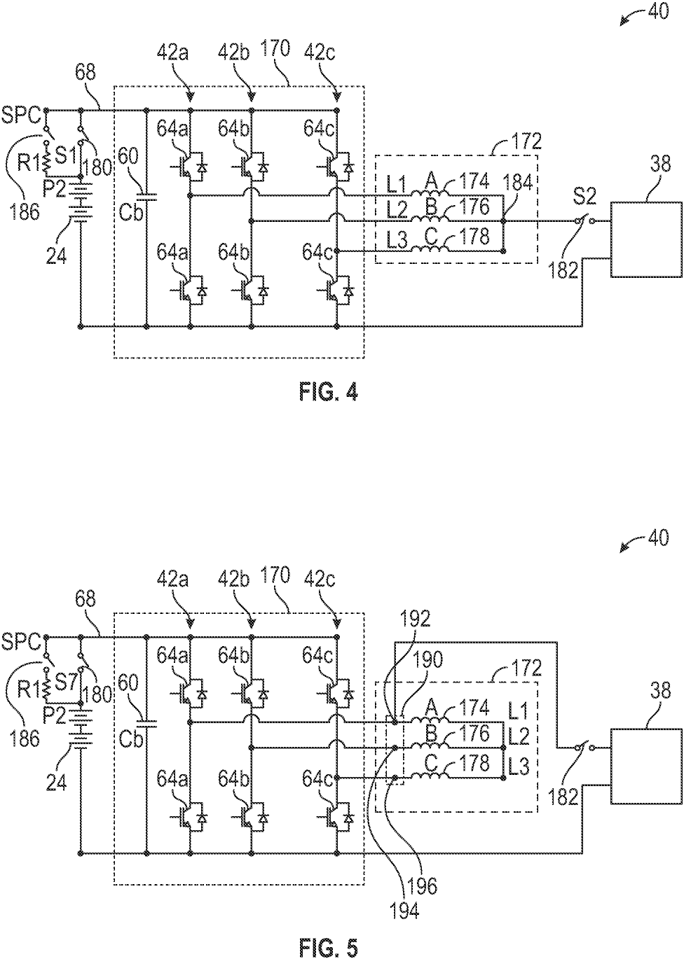

FIGS. 4 and 5 depict embodiments in which the conversion device 40 incorporates components of a vehicle inverter system 170. The inverter system 170 is connected to an electric motor 172 of a vehicle (e.g., the motor assembly 20 of FIG. 1). The electric motor 172 in these embodiments uses a three phase motor having three phase motor windings. For example, the motor 172 includes a phase A motor winding 174, a phase B motor winding 176 and a C phase motor winding 178. One or more of the motor windings are used as inductors of one or more buck-boost modules 42. The motor 172 is not limited to a three phase motor, as the motor can have any number of phases (e.g., as a 5, 6, 7 or 9 phase motor).

In an embodiment, shown in FIG. 4, the phase A motor winding 174 forms the inductor (L1) of the buck-boost module 42a, the phase B motor winding 176 forms the inductor (L2) of the buck-boost module 42b, and the phase C motor winding 178 forms the inductor (L3) of a buck-boost module 42c, which includes a set of switches 64c. It is noted that the conversion device 40 may include fewer than three modules.

A switch 180 (S1) is provided between the battery pack 24 and the positive bus 68, and a switch 182 (S2) is provided between a neutral point 184 of the motor 172 and the charge port 38. The charge port 38 may be connected to a charging station, other vehicle or other energy storage system.

As shown, the conversion device 40 includes three buck-boost modules, in which each buck-boost module is connected to a respective motor winding. However, the conversion device 40 is not so limited, as the conversion device may have fewer buck-boost modules. For example, the conversion device 40 may use a single winding (e.g., L1), or two windings (e.g., L1 and L2, L2 and L3, etc.)

An inverter pre-charge switch 186 (SPC) is connected to a resistance R1 and allows for selective engagement of the inverter 170 with the motor 172 to supply power thereto. The inverter 170 can be converted for charging by opening the inverter pre-charge switch 186, and closing the switches 180 and 182. To reengage the battery pack 24 to supply power to the motor 172, the switches 180 and 182 are opened and the inverter switch 186 is closed.

FIG. 5 depicts an embodiment of the conversion device 40 in which the charge port 38 is connected to a terminal of the motor 172. The charge port 38 may be connected via a terminal to any desired winding. For example, as shown in FIG. 5, the motor 172 includes or is connected to a terminal block 190 having connections 192, 194 and 196. The charge port 38 and the switch 182 are connected to the connection 192, although the charge port can be connected to any connection 192, 194 or 196. By controlling the inverter switch 186, the conversion device 40 can selectively use at least two windings (e.g., windings 174 and 176) with one inverter leg (e.g., leg L2) to form a buck-boost system, or can use three windings associated with two inverter legs (e.g., legs L2 and L3) to form a buck-boost system.

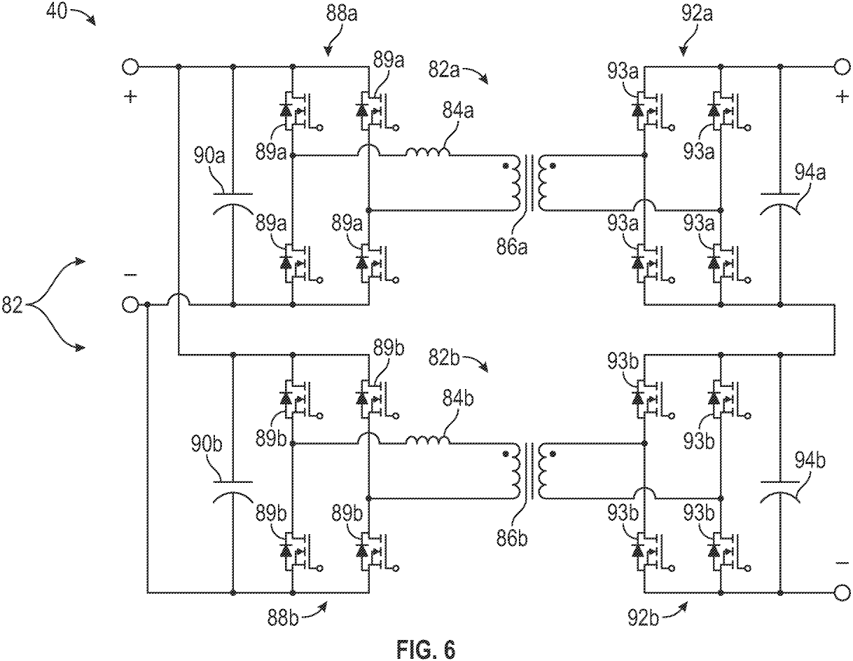

FIG. 6 depicts an embodiment of the conversion device 40 for providing scalable and modular bi-directional power flow. The conversion device 40 in this embodiment includes one or more dual active bridge (DAB) buck-boost modules 82. Each DAB module 82 includes a full bridge at each side of a high frequency transformer, an energy transfer inductor, and capacitors at the input and output side of the circuit.

In an embodiment, the conversion device 40 is modular, allowing for individual DAB modules to be added to scale the conversion device 40. FIG. 6 depicts two modular buck-boost modules 82a and 82b connected in parallel, although any number of modules may be included as desired. The module 82a includes a power transfer inductor 84a and a transformer 86a. One side of the transformer 86a is connected to a first full bridge 88a connected in parallel to a capacitor 90a. The first full bridge 88a includes switches 89a. Another side of the transformer 86a is connected to a second full bridge 92a including switches 93a, and a capacitor 94a. The transformer 86a isolates the first full bridge 88a from the second full bridge 92a.

Similarly, the module 82b includes a power transfer inductor 84b and a transformer 86b. One side of the transformer 86b is connected to a first full bridge 88b (including switches 89b) and a capacitor 90b, and another side of the transformer 86b is connected to a second full bridge 92b (including switches 93b) and a capacitor 94b.

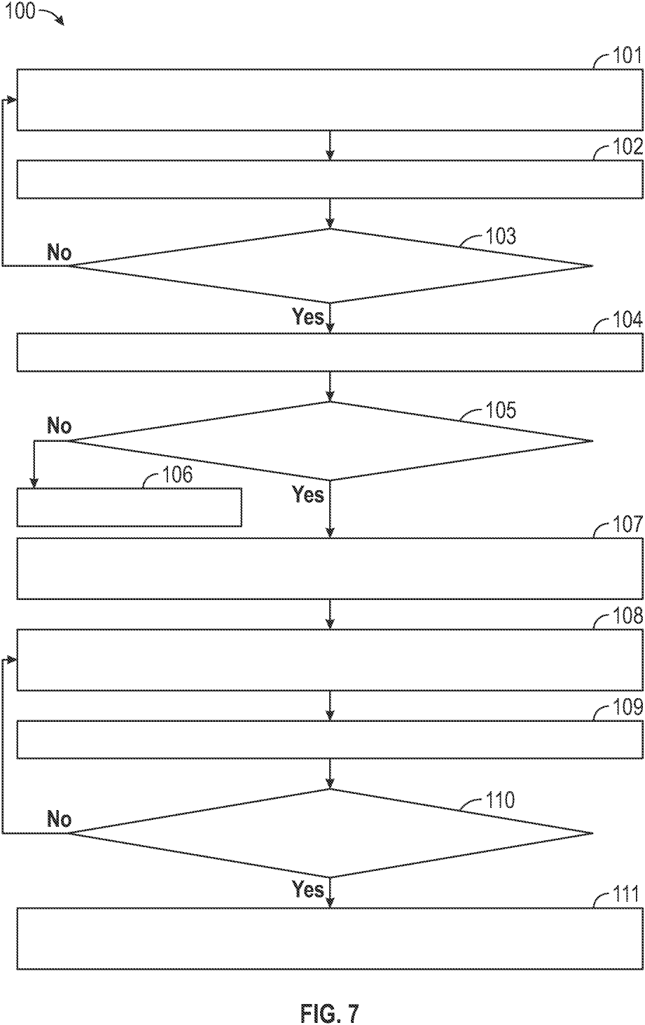

FIG. 7 illustrates embodiments of a method 100 of controlling the conversion device 40 and transferring charge between two energy storage systems. In the method 100, charge is transferred from a vehicle battery of a first vehicle to a battery assembly of a second vehicle. Aspects of the method 100 may be performed by a processor or processors disposed in a vehicle, such as the controller 44, the OCBM 34 and/or the computer system 48. It is noted the method 100 is not so limited and may be performed by any suitable processing device or system, or combination of processing devices.

The method 100 includes a number of steps or stages represented by blocks 101-111. The method 100 is not limited to the number or order of steps therein, as some steps represented by blocks 101-111 may be performed in a different order than that described below, or fewer than all of the steps may be performed.

The method 100 is described in conjunction with the vehicle 10 and the conversion device of FIG. 2 for illustration purposes. The method 100 is not so limited and can be used with any suitable vehicle battery system. In addition, the method 100 may be used with the conversion device of FIG. 3 or FIG. 4, or any other device having buck-boost modules as described herein.

At block 101, the processing device determines if it is desired to charge a second vehicle battery by transferring energy from the battery pack 24 of the vehicle 10. This may be determined based on user input, a wireless signal from the second vehicle or other information. The processing device also determines charge parameters such as the second vehicle’s nominal battery voltage, maximum allowable charge current and desired charge energy.

At block 102, the available battery energy in the battery pack 24 is measured or detected, and a final desired charge current is determined based on the available energy and the desired energy.

At block 103, it is determined whether vehicle to vehicle (V2V) or vehicle-to-X (V2X) charging is available, for example, by checking whether a charge enabled signal is set. If the signal is not set, an error signal is output and/or the method returns to block 101.

At block 104, if the charge enable signal is set, the second vehicle is connected (e.g., via a charge cable) to the charge port 38. The voltage of the second vehicle’s battery (second vehicle battery voltage) is read.

At block 105, the processing device determines whether the second vehicle battery voltage is within a selected range of the battery pack 24 voltage (the first vehicle battery voltage). If the second vehicle battery voltage is outside of the selected range, an error or voltage fault signal is output (block 106).

At block 107, the charging current support by the second vehicle battery is determined, as well as the maximum current supported by the battery pack 24 and the second vehicle battery.

At block 108, the conversion device 40 is operated to control the output voltage applied to the second vehicle battery, as well as to control the charging currents. The conversion device 40 may operate one or more of the buck-boost modules 42. For example, the number of modules used is determined by the desired charging current.

During operation, if multiple buck-boost modules 42 are operated during charge transfer, they may be synchronized and have a programmable phase shift. The phase shift is selected based on the number of modules 42 being operated to reduce or minimize input and output current ripple.

Furthermore, if multiple buck-boost modules 42 are used, the conversion device 40 may selectively operate individual buck-boost modules 42 to balance the thermal distribution among the modules 42. For example, the conversion device 42 includes three buck-boost modules (i.e., modules 42a, 42b and one module 42n (FIG. 2)). The conversion device 40 can alternate between modules 42a, 42b and 42n for a given time period. For example, the controller 44 transfers charge using the module 42a for a selected time period T, uses module 42b for a successive time period T, and then uses the module 42n for the next time period T. The controller 44 can repeat this sequence over the total charging time. In another example, the controller can operate 42a and 42n concurrently over the time period T, then operate 42b and 42n, and subsequently operate 42a and 42n (and repeat this sequence as desired).

At block 109, the charging energy supplied to the second vehicle battery is calculated based on charge voltage, current and time.

At block 110, the charging energy is continuously or periodically compared to the final desired charge energy. The charging continues until the charging energy reaches the desired amount.

At block 111, when the desired charge energy is transferred, the conversion device 40 is disabled and the charge port 28 is disconnected. An appropriate signal or communication is output to indicate completion of the charging method.

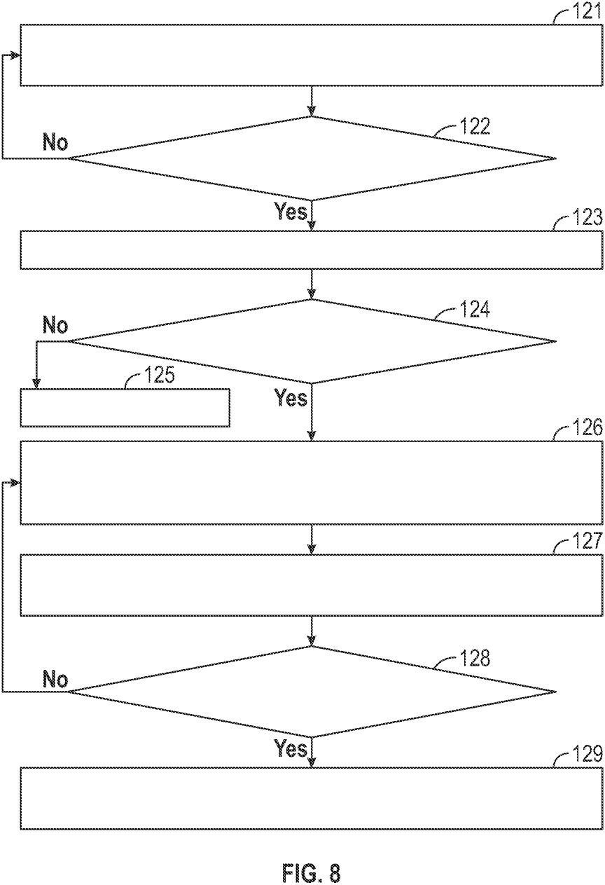

FIG. 8 illustrates embodiments of a method 120 of controlling the conversion device 40 and transferring charge between two energy storage systems. In the method 120, charge is transferred from a charging station to a vehicle battery assembly (e.g., from the charging station 56 to the battery pack 24 of FIG. 1). The conversion device 40 and the method 120 provide for backward compatibility, or compatibility between a high voltage vehicle battery assembly and a lower voltage charge station. For example, the vehicle battery is an 800 V system, and the charge station is a 400 V system.

Aspects of the method 120 may be performed by a processor or processors disposed in a vehicle, such as the controller 44, the OCBM 34 and/or the computer system 48. It is noted the method 120 is not so limited and may be performed by any suitable processing device or system, or combination of processing devices.

The method 120 is described in conjunction with the vehicle 10 and the conversion device of FIG. 2 for illustration purposes. The method 120 is not so limited and can be used with any suitable vehicle battery system. In addition, the method 120 may be used with the conversion device of FIG. 3 or FIG. 4, or any other device having buck-boost modules as described herein.

The method 120 includes a number of steps or stages represented by blocks 121-129. The method 100 is not limited to the number or order of steps therein, as some steps represented by blocks 121-129 may be performed in a different order than that described below, or fewer than all of the steps may be performed.

At block 121, the processing device reads the vehicle 10 charge settings, including desired charge energy. At block 122, the conversion device 40 is enabled (e.g., via an enable signal).

At block 123, the charging station 56 is connected to the vehicle 10 via the charge port 38. The charge station voltage may be read at this point.

At block 124, it is determined whether the charging station voltage is within a selected range of the battery pack voltage. If the charging station voltage is outside of the range, an error signal or voltage fault signal is output (block 125).

At block 126, the conversion device 40 is operated to control the charging current and the voltage applied to the battery pack 24 from the charge station 56. The buck-boost modules 42, for example, step up the input voltage from the charge station to 800 V. The conversion device 40 may operate one or more of the buck-boost modules 42 based on the desired charging current as discussed above, and may also selectively operate individual buck-boost modules 42 as needed to balance the thermal distribution among the modules 42.

At block 127, the charging energy supplied to the battery pack 24 is calculated based on charge voltage, current and time.

At block 128, the charging energy is continuously or periodically compared to the final desired charge energy. The charging continues until the charging energy reached the desired amount.

At block 129, when the desired charge energy is transferred, the conversion device 40 is disabled and the charge port 38 is disconnected. An appropriate signal or communication is output to indicate completion of the charging method.

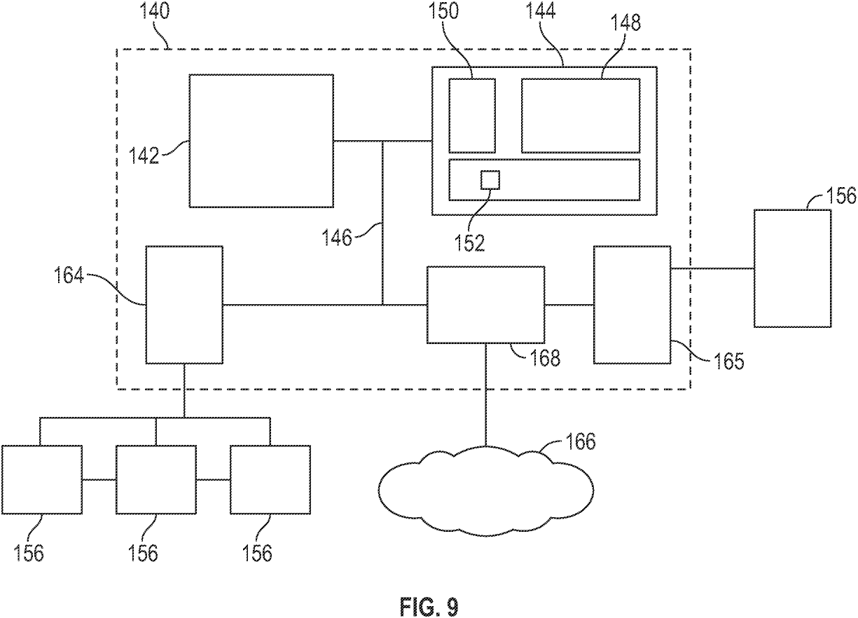

FIG. 9 illustrates aspects of an embodiment of a computer system 140 that can perform various aspects of embodiments described herein. The computer system 140 includes at least one processing device 142, which generally includes one or more processors for performing aspects of image acquisition and analysis methods described herein.

Components of the computer system 140 include the processing device 142 (such as one or more processors or processing units), a memory 144, and a bus 146 that couples various system components including the system memory 144 to the processing device 142. The system memory 144 can be a non-transitory computer-readable medium, and may include a variety of computer system readable media. Such media can be any available media that is accessible by the processing device 142, and includes both volatile and non-volatile media, and removable and non-removable media.

For example, the system memory 144 includes a non-volatile memory 148 such as a hard drive, and may also include a volatile memory 150, such as random access memory (RAM) and/or cache memory. The computer system 140 can further include other removable/non-removable, volatile/non-volatile computer system storage media.

The system memory 144 can include at least one program product having a set (e.g., at least one) of program modules that are configured to carry out functions of the embodiments described herein. For example, the system memory 144 stores various program modules that generally carry out the functions and/or methodologies of embodiments described herein. A module or modules 152 may be included to perform functions related to controlling charging operations as discussed herein. The system 140 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 142 can also communicate with one or more external devices 156 as a keyboard, a pointing device, and/or any devices (e.g., network card, modem, etc.) that enable the processing device 142 to communicate with one or more other computing devices. Communication with various devices can occur via Input/Output (I/O) interfaces 164 and 165.

The processing device 142 may also communicate with one or more networks 166 such as a local area network (LAN), a general wide area network (WAN), a bus network and/or a public network (e.g., the Internet) via a network adapter 168. It should be understood that although not shown, other hardware and/or software components may be used in conjunction with the computer system 40. Examples include, but are not limited to: microcode, device drivers, redundant processing units, external disk drive arrays, RAID systems, and data archival storage systems, etc.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A charging system of a vehicle, comprising:
a conversion device configured to transfer an electric charge between a battery assembly of the vehicle and an energy storage system, the battery assembly having a first voltage and the energy storage system having a second voltage, the conversion device including a scalable buck-boost system having a plurality of buck-boost modules, each buck-boost module of the plurality of buck-boost modules including a set of switches and an inductor; and
a controller configured to operate one or more buck-boost modules of the plurality of buck-boost modules during transfer of charge between the battery assembly and the energy storage system.

2. The charging system of claim 1, wherein the first voltage is greater than the second voltage.

3. The charging system of claim 1, wherein the set of switches includes a half bridge switch module or a full bridge switch module.

4. The charging system of claim 1, wherein the scalable buck-boost system includes at least one of a standalone conversion device, and one or more components of a vehicle propulsion assembly.

5. The charging system of claim 3, wherein each buck-boost module includes a dual active bridge circuit configured for bi-directional power flow.

6. The charging system of claim 1, wherein the buck-boost system includes an input capacitor and an output capacitor connected to the plurality of buck-boost modules.

7. The charging system of claim 1, wherein the controller is configured to operate one or more selected buck-boost modules, a number of the selected buck-boost modules determined based on a charging parameter of at least one of the battery assembly and the energy storage system.

8. The charging system of claim 1, wherein the controller is configured to selectively operate different buck-boost modules to balance a thermal distribution of the conversion device.

9. A method of transferring charge, comprising:
connecting a charging system of a vehicle to an energy storage system, the charging system configured to control energy transfer to and from a battery assembly of the vehicle, the battery assembly having a first voltage and the energy storage system having a second voltage, the charging system including a conversion device, the conversion device including a scalable buck-boost system having a plurality of buck-boost modules, each buck-boost module of the plurality of buck-boost modules including a set of switches and an inductor; and
transferring charge between the battery assembly and the energy storage system, wherein the transferring includes operating one or more buck-boost modules of the plurality of buck-boost modules by a controller to conform an output voltage to the first voltage or the second voltage.

10. The method of claim 9, wherein the energy transfer is from the battery assembly to the energy storage system.

11. The method of claim 10, wherein the first voltage is greater than the second voltage, and at least one of the plurality of buck-boost modules is controlled to reduce an input voltage from the battery assembly to an output voltage corresponding to the second voltage.

12. The method of claim 10, wherein the first voltage is less than the second voltage, and at least one of the plurality of buck-boost modules is controlled to increase an input voltage from the battery assembly to an output voltage corresponding to the second voltage.

13. A vehicle system, comprising:
a battery assembly; and
a charging system configured to transfer an electric charge between the battery assembly and an energy storage system, the battery assembly having a first voltage and the energy storage system having a second voltage, the charging system including:
a conversion device including a scalable buck-boost system having a plurality of buck-boost modules, each buck-boost module of the plurality of buck-boost modules including a set of switches and an inductor; and
a controller configured to operate one or more buck-boost modules of the plurality of buck-boost modules during transfer of charge between the battery assembly and the energy storage system.

14. The vehicle system of claim 13, wherein the first voltage is greater than the second voltage.

15. The vehicle system of claim 13, wherein the set of switches includes a half bridge switch module or a full bridge switch module.

16. The vehicle system of claim 13, wherein the scalable buck-boost system includes at least one of a standalone conversion device, and one or more components of a vehicle propulsion assembly.

17. The vehicle system of claim 16, wherein each buck-boost module includes a dual active bridge circuit configured for bi-directional power flow.

18. The vehicle system of claim 13, wherein the buck-boost system includes an input capacitor and an output capacitor connected to the plurality of buck-boost modules.

19. The vehicle system of claim 13, wherein the controller is configured to operate one or more selected buck-boost modules, a number of the selected buck-boost modules determined based on a charging parameter of at least one of the battery assembly and the energy storage system.

20. The vehicle system of claim 13, wherein the controller is configured to selectively operate different buck-boost modules to balance a thermal distribution of the conversion device.
